(19) United States
(12) Patent Application Publication
(10) Pub. No.: US 2013/0321135 A1
(43) Pub. Date: Dec. 5, 2013

(54) REMOTE CONTROL AND REMOTE CONTROL ASSEMBLY

(71) Applicant: HON HAI PRECISION INDUSTRY CO., LTD., New Taipei (TW)

(72) Inventors: HONG-SHENG CHEN, New Taipei (TW); KUO-CHUN HUANG, New Taipei (TW)

(73) Assignee: HON HAI PRECISION INDUSTRY CO., LTD., New Taipei (TW)

(21) Appl. No.: 13/726,612

(22) Filed: Dec. 26, 2012

(30) Foreign Application Priority Data
May 30, 2012 (TW) 101210397

(51) Int. Cl. H04N 5/44

(52) U.S. Cl. CPC H04N 5/4403
USPC 340/12.54; 340/12.22; 348/734; 704/275

(57) ABSTRACT

A remote control for controlling an electronic device includes a first control panel and a second control panel. When the remote control is in a first operating state, the first control panel closes relative to the second control panel. The first control panel is used to receive operations from a user. When the remote control is in the second operating state, the first control panel opens relative to the second control panel in a first direction, both the first and second control panels are used to receive operations from a user. A remote control assembly is also provided.

### BACKGROUND

1. Technical Field

The present disclosure relates to remote control assembly.

2. Description of Related Art

Electronic devices such as televisions, video players, and digital video disc (DVD) players can be controlled with a remote control having various keys or buttons. In recent years, there have been available televisions and set-top boxes that can be connected to the Internet. However, when the televisions are connected to the Internet, the user has to connect another input device, such as a keyboard and a mouse, to the television, for operating the televisions, which is inconvenient for the user.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a perspective view of a remote control for an electronic device;

FIG. 2 is perspective view showing the remote control of FIG. 1 being in a first operating state.

FIG. 3 is a perspective view showing the remote control of FIG. 1 being in a second operating state.

FIG. 4 is a perspective view showing the remote control of FIG. 1 being in a third operating state.

### DETAILED DESCRIPTION

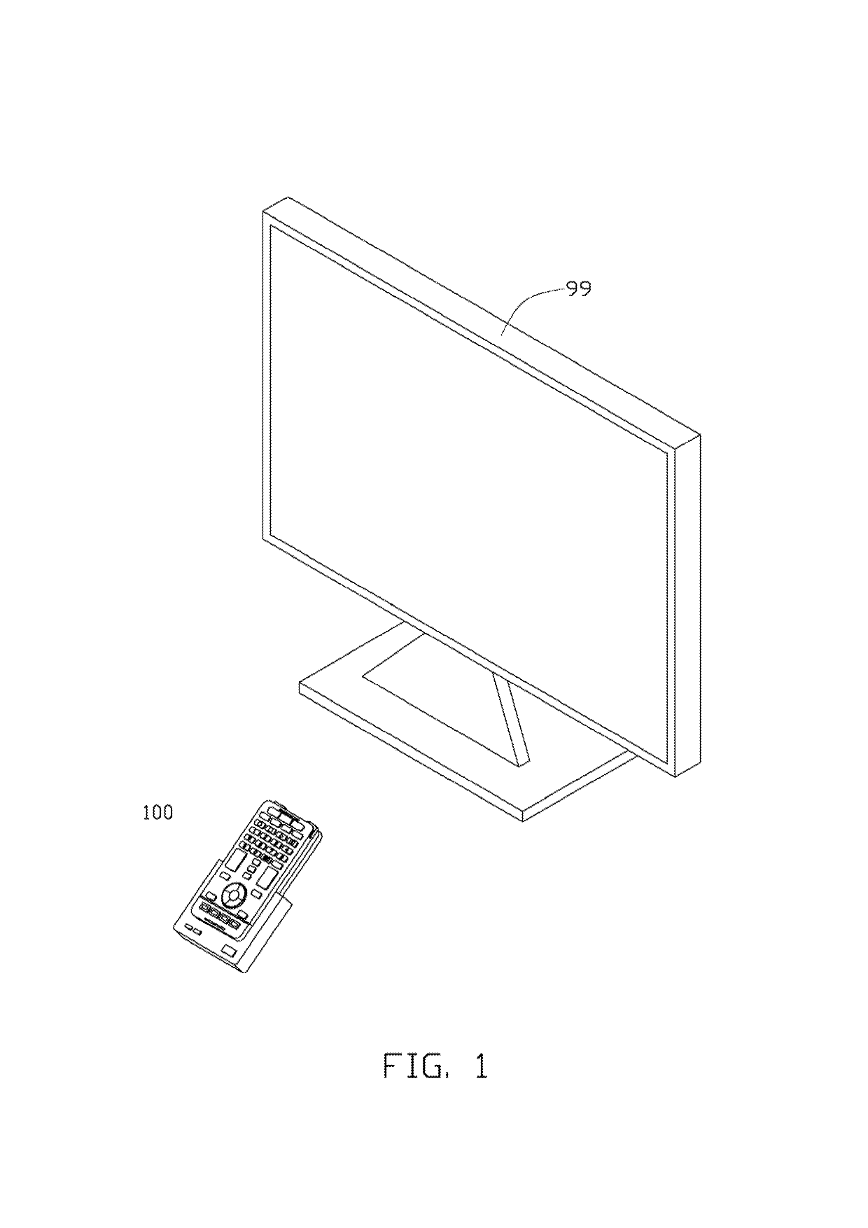

FIG. 1 is a remote control assembly 100 for an electronic device 99. The remote control assembly 100 is used for controlling the electronic device 99 in response to the operations of a user. The electronic device 99 may be a television, a video player, and a digital versatile disc (DVD) player. In the embodiment, the electronic device 99 is a television, which can be connected to Internet.

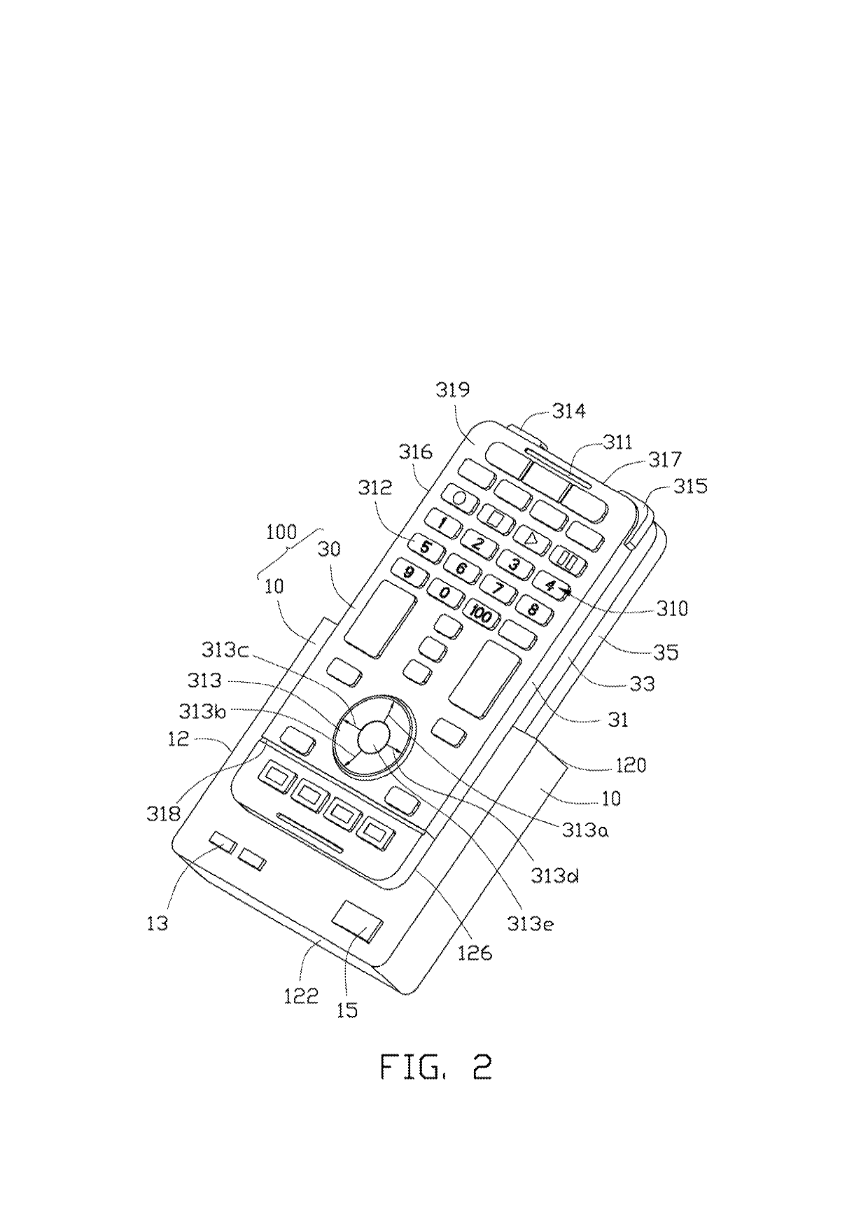

FIG. 2 shows that the remote control assembly 100 includes a docking station 10 and a remote control 30 with a communicating unit 315. The communicating unit 315 is capable of communicating with the docking station 10 and the remote control 30, which will be explained below.

The docking station 10 is substantially U-shaped, and may be in a working state and a non-working state. The docking station 10 includes a body 12, an indicating light 13 and a finder button 15. The body 12 includes an upper wall 120 and a lower wall 122 opposite to the upper wall 120. The upper wall 120 recesses toward the lower wall 122 to form a notch 126 for receiving the remote control 30. A connector (not shown) is secured to the bottom of the notch 126 for electrically connecting the remote control 30 with the docking station 10. The indicating light 13 is positioned on a surface of the body 12 for indicating the state of the docking station 10. The finder button 15 is positioned on the same surface of the body 12 as the indicating light 13. When the users actuate the finder button 15, the docking station 10 is capable of detecting whether the remote control 30 is within a predetermined distance and generates a detecting signal if the remote control 30 is detected to be within the predetermined distance. The communicating unit 315 in response to the detecting signal controls the remote control 30 to produce an audible sound, for locating the remote control 30. In the embodiment, the detecting signal from the finder button 15 is Bluetooth® signal. In other embodiment, the detecting signal can be infrared signal.

The remote control 30 is capable of being used in three different operating states (herein after as a first operating state, a second operating state and a third operating state). The remote control 30 includes a first control panel 31, a second control panel 33, and a third control panel 35. The second control panel 33 is arranged between the first control panel 31 and the third control panel 35. The first and third control panels 31, 35 are slidably coupled to opposite ends of the second control panel 33, and can be opened and closed relative to the second control panel 33.

The first control panel 31 is substantially rectangular-shaped, and includes a first plated body 316, a plurality of keys 310 and an earpiece 311. In the embodiment, the first control panel 31 is a television control panel functioning as a typical television remote control to control the electronic device 99, such as channel selection and volume control.

The first plated body 316 includes a first sidewall 317, a second sidewall 318 opposite to the first sidewall 317, and a first surface 319. The first surface 319 is opposite to the second control panel 33. The keys 310 include a plurality of operation keys 312, an orientation key 313, and a power key 314.

The operation keys 312 are typical television buttons including channel selection buttons, volume control buttons and so on. The orientation key 313 is rotatably positioned on the upper surface 319 and can be switched between a first position and a second position. The orientation key 313 includes four cursor keys 313a, 313b, 313c, and 313d and a central key 313e. The four cursor keys 313a, 313b, 313c, and 313d are assigned the functions “up”, “down”, “left” and “right” in the sequence indicated. The arrow symbols shown on the four cursor keys 313a, 313b, 313c, and 313d are adapted to indicate the orientation of the remote control 30.

The power key 314 is positioned on an end of the first sidewall 317 for turning on/off the electronic device 99. The communicating unit 315 is positioned on an end of the first sidewall 317 opposite to the power key 314, and can transmit a controlling signal to the electronic device 99 in response to an operation of a user.

The earpiece 311 is arranged opposite ends of the upper surface 319. The earpiece 311 is arranged adjacent to the first sidewall 317 for outputting a voice signal from the electronic device 99 and the remote control 30, such as, an IP voice call from the electronic device 99 which is connected to Internet, and the audible sound output from the remote control 30.

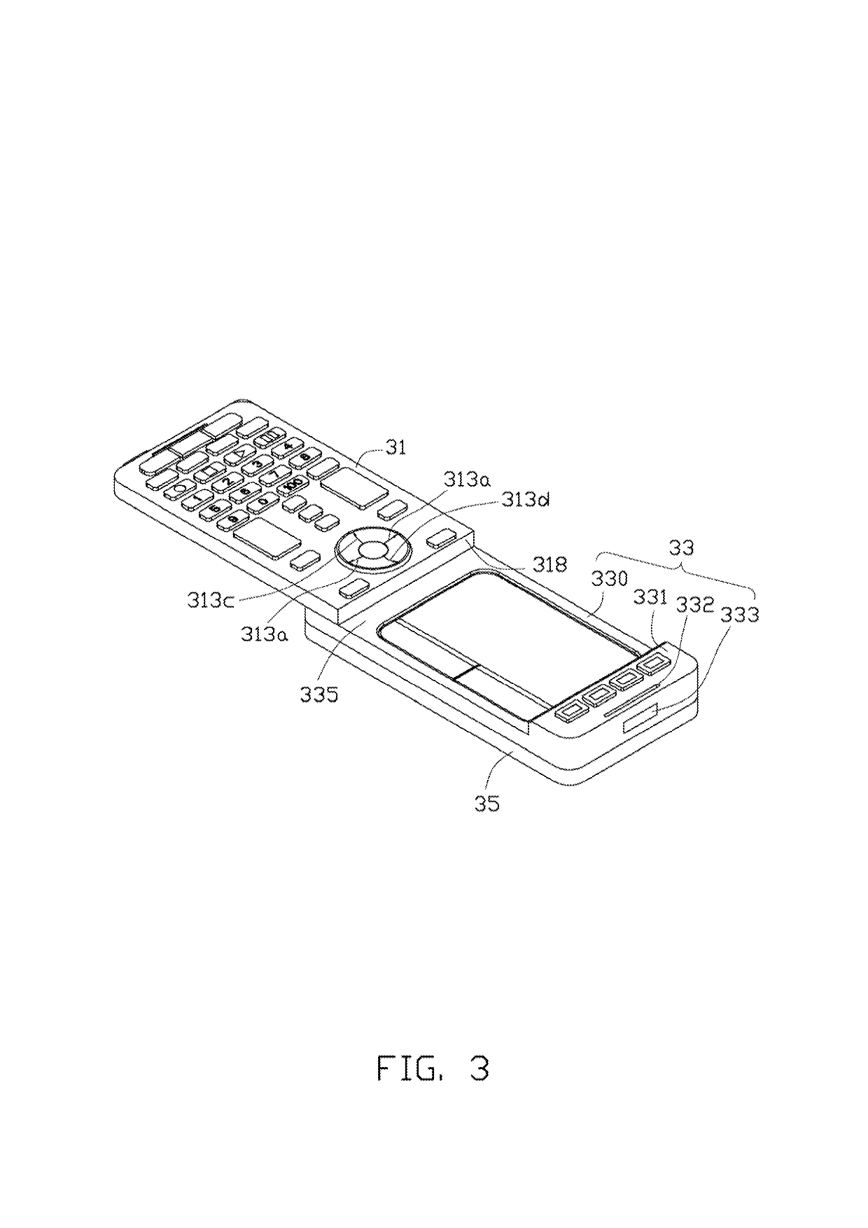

FIG. 3 shows that the second control panel 33 includes a second plate body 330, a protrusion 331, a mouthpiece 332 and an interface 333. In the embodiment, the second control panel 33 is a touch panel.

The second plate body 330 includes a second surface 335 facing the first control panel 31. The protrusion 331 is secured to an end of second plate body 330 away form the first control panel 31 and protrudes out of the second surface 335. The height of the protrusion 331 is equal to the sum height of the first plate body 316 and the height of the second plate body 330. When the first control panel 31 closes to the second control panel 33 (see FIG. 2), the second sidewall 318 abuts an end of the protrusion 331 facing the second surface 335; when the first control panel 31 slides relative to the second control panel 33 in a direction away from the protrusion 331, the second sidewall 318 is apart from the protrusion 331 and is adjacent to an end of the second plate body 330 opposite to the protrusion 331, and the second control panel 33 is exposed out for receiving touch operations from a user.

The mouthpiece 332 is arranged on a surface of the protrusion 331 opposite to the second surface 335, and is substantially coplanar with the earpiece 311. The mouthpiece 332 is used for receiving a voice signal and processes the voice signal and transmits the voice signal to the electronic device, for example, during for an IP voice call using the electronic device 99 which is connected to Internet, the remote control 30 receives and outputs audible sound from the earpiece 311. The interface 333 is positioned on an end of the protrusion 331 opposite to the first control panel 31 for engaging with the plug in the notch 126.

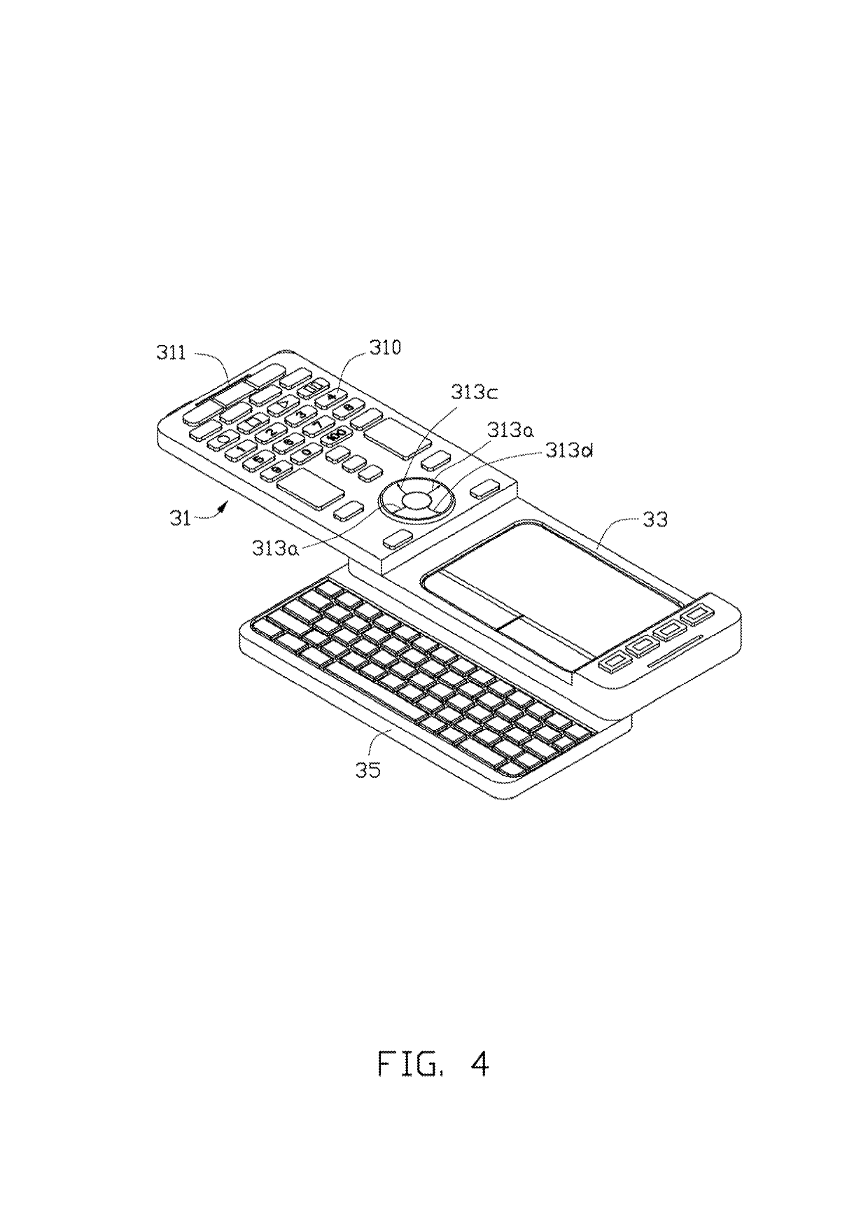

FIG. 4 shows that the third control panel 35 is slidably secured to a surface of the second control panel 33 opposite to the first control panel 31. In the embodiment, the third control panel 35 is a computer keyboard.

In use, when the first, second and third control panels 31, 33 and 35 are fold up, the remote control 30 is in a first operating state (see FIG. 2), and the user can control the electronic device 99 via operating the first control panel 31.

When the first control panel 31 slides relative to the second control panel 33 in a first direction perpendicular to the first sidewall 317, the remote control 30 is in a second operating state (see FIG. 3). In this state, the second control panel 33 is exposed out, thus, the user further can control the electronic device 99, via operating the second control panel 33, relative to the first operating state.

When the third control panel 35 slides relative to the second control panel 33 in a second direction perpendicular to the first direction, the remote control 30 is in a third operating state (see FIG. 4), In this state, the third control panel 35 is exposed out, thus, the user further can control the electronic device 99, via operating the third control panel 35, relative to the second operating state.

In first, second and third operating states, when the user operates the remote control 30 in the longitudinal direction of the second control panel 33, the orientation key 313 can be rotated to the first position (see FIG. 2); when the use operates the remote control 30 in the latitudinal direction of the second control panel 33, the orientation key 313 can be rotated to the second position (see FIGS. 3 and 4) which the cursor key 313a rotates clockwise 90 degree, for engaging with the current operating state of the remote control 30.

In FIG. 2, when the remote control 30 is received in the notch 126 with the plug inserted into the interface 333, the indicating light 13 flashes intermittently for indicating the docking station 10 is in the working state, and the remote control 30 is charged-up by the docking station 10. When the remote control 30 is removed out of the notch 126, the indicating light 13 turns off indicating the docking station 10 is in the non-working state, and the remote control 30 is not being charged by the docking station 10.

In another embodiment, the sliding direction among the first, second and third control panels 31, 33 and 35 can be changed according to the need, for example, the first and third control panels 31, 35 can rotate to the second control panel 33; the first and third control panels 31, 35 can slide to the second control panel 33 in the direction parallel to the third sidewall 318.

Although information and the advantages of the present embodiments have been set forth in the foregoing description, together with details of the structures and functions of the present embodiments, the disclosure is illustrative only; changes may be made in detail, especially in the matters of shape, size, and arrangement of parts within the principles of the present embodiments to the full extent indicated by the broad general meaning of the terms in which the appended claims are expressed.

What is claimed is:

1. A remote control assembly for controlling an electronic device, comprising:
a remote control comprising:
a first control panel; and
a second control panel coupled to the first control panel;
wherein the remote control is capable of being operated in a first operating state and a second operating state, when the remote control is in the first operating state, the first control panel closes relative to the second control panel, and the first control panel is used to receive operations from a user; when the remote control is in the second operating state, the first control panel opens relative to the second control panel in a first direction, both the first and second control panels are used to receive operations from a user.

2. The remote control assembly as claimed in claim 1, further comprises a docking station; the remote control is capable of being electrically connected to the docking station, for being charged-up by the docking station.

3. The remote control assembly as claimed in claim 1, wherein the remote control further comprises a docking station, the docking station is capable of detecting whether the remote control is within a predetermined distance when actuated, and generates a detecting signal if the remote control is detected to be within the predetermined distance; the remote control detects the detecting signal and produces an audible sound.

4. The remote control assembly as claimed in claim 3, wherein the remote control comprises a communicating unit used for detecting the detecting signal from the docking station to control the remote control to produce the audible sound and the communicating unit is further capable of controlling the electronic device in responses to user's operation.

5. The remote control assembly as claimed in claim 1, wherein the remote control comprises a third control panel, the third control panel is coupled to the second control panel; when the remote control is in a third operating state, the third control panel is opened relative to the second control panel in a second direction, and the third control panel is used to receive operations from a user.

6. The remote control assembly as claimed in claim 5, wherein when the remote control is in the third operating state, the first and third control panels are opened relative to the second control panel, the first, second and third control panels are used to receive operations from a user.

7. The remote control assembly as claimed in claim 6, wherein the first direction is perpendicular to the second direction.

8. The remote control assembly as claimed in claim 5, wherein the second control panel is arranged between the first control panel and the second control panel.

9. The remote control assembly as claimed in claim 5, wherein when the remote control is in the first operating state, the first and third control panels close relative to the second control panel.

10. The remote control assembly as claimed in claim 1, wherein the first control panel comprises a plate body and an orientation key positioned on the plate body; the orientation key is capable of being rotated between a first position and a second position relative to the plate body, for engaging with the current operating state of the remote control.

11. The remote control assembly as claimed in claim 5, wherein the first control panel is a television control panel, the second control panel is a touch panel, and the third control panel is a keyboard.

12. The remote control assembly as claimed in claim 1, wherein the first control panel comprises an earpiece, and the second control panel comprises a mouthpiece; the earpiece is capable of outputting a voice signal from the electronic device and the remote control, the mouthpiece receives voice signals from the electronic device.

13. A remote control for controlling an electronic device, the remote control capable of being operated in a first operating state and a second operating state, comprising:
a first control panel; and
a second controlling coupled to the first control panel;
wherein when the remote control is in the first operating state, the first control panel closes relative to the second control panel, and the first control panel is used to receive operations from a user; when the remote control is in the second operating state, the first control panel opens relative to the second control panel in a first direction, both the first and second control panels are used to receive operations from a user.

14. The remote control as claimed in claim 13, further comprises a third control panel, the third control panel is coupled to the second control panel; when the remote control is in a third operating state, the third control panel is opened relative to the second control panel in a second direction.

15. The remote control as claimed in claim 14, wherein when the remote control is in the third operating state, the first and third control panels are opened relative to the second control panel.

16. The remote control as claimed in claim 14, wherein the second control panel is arranged between the first control panel and the second control panel.

17. The remote control as claimed in claim 14, wherein when the remote control is in the first operating state, the first and third control panels closes relative to the second control panel.

18. The remote control as claimed in claim 13, wherein the first control panel comprises a plate body and an orientation key positioned on the plate body; the orientation key is capable of being rotated between a first position and a second position relative to the plate body for engaging with the current operating state of the remote control.

19. The remote control as claimed in claim 14, wherein the first control panel is a television control panel, the second control panel is a touch panel, and the third control panel is a keyboard.

20. The remote control assembly as claimed in claim 13, wherein the first control panel comprises an earpiece, and the second control panel comprises a mouthpiece; the earpiece is capable of outputting a voice signal from the electronic device and the remote control, the mouthpiece receives voice signals from the electronic device.
